(19) United States
(12) Patent Application Publication
(10) Pub. No.: US 2021/0083868 A1
(43) Pub. Date: Mar. 18, 2021

(54) DYNAMIC SECRET KEY SECURITY SYSTEM FOR TEST CIRCUIT AND METHOD OF THE SAME

(71) Applicant: NATIONAL CHENG KUNG UNIVERSITY, Tainan City (TW)

(72) Inventors: KUEN-JONG LEE, TAINAN CITY (TW); CHIA-CHI WU, TAINAN CITY (TW); MAN-HSUAN KUO, TAINAN CITY (TW)

(21) Appl. No.: 16/572,787

(22) Filed: Sep. 17, 2019

(51) Int. Cl. H04L 9/08; G06F 9/30; G01R 31/3177

(52) U.S. Cl. CPC H04L 9/0861; G01R 31/3177; G06F 9/30134; H04L 9/088

(57) ABSTRACT

A dynamic secret key security system for test circuit and a method of the same are disclosed. The security architecture includes a scan chain set, a dynamic key generator, a secret key checking logic, a fake response generator, and a controller. Scan chains of the scan chain set receive a test vector while the dynamic key generator produces different secret keys according to the test vector received. The secret key checking logic is used for comparing the test vector with the secret key so as to know whether they are the same. Thus whether the test vector being input is legal can be learned. Thereby the present dynamic secret key generation technique provides higher security level. Moreover, the secret key will not be stored in the memory in advance so that attackers cannot get the secret key through attacks on the memory.

### BACKGROUND OF THE INVENTION

### Field of the Invention

The present invention relates to a dynamic secret key security system for test circuit and a method of the same, especially to a dynamic secret key security system for test circuit and a method of the same by which different secret keys are generated according to test vectors being input. Whether the test vector being input is safe is learned after being compared with the secret key for protecting the system against scan-based attacks.

### Description of Related Art

People with bad intentions may get access to confidential information therein such as encryption key or circuit design through test circuitry of electronic systems without any protective measures. Moreover, companies or users may suffer tremendous loss owing to system failure/crash resulted from system intrusion. Generally, the attacks are divided into two categories—Scan-based side channel attack and Memory attack. The scan-based side channel attack is based on the scan architecture and features of the scan design. Owing to observability and controllability of the scan design, the attacker can get into the circuitry and obtain the confidential data therein.

The cold boot attack that is a technique designed to take advantage of the decay feature of DRAM for acquiring the contents of the computer system's memory. As an attacker-controlled lightweight operating system is connected to the target memory and the system is rebooted, confidential data is simply read out before all traces of the data in the memory fade away. This attack is one of physical attacks and software protection methods are no longer effective. Thus a hardware defense against the memory attack is required.

The scan attack can be thwarted by three ways. The first method is the scan architecture is disconnected or broken directly after manufacturing test. Yet the method can't provide the capability of in-field test. Another way is to limit the amount of data that users are allowed to observe such as the attacker can only observe the final result. The shortcoming of this way is the reduction of the diagnosis capability. The third way is to obfuscate or change the test architecture. For example, the key register in the circuit is replaced by a mirror key register (MKR). Thus the real key register is not included in the scan chain. The shortcoming of this method is that the test coverage is decreased.

In order to obfuscate or change the test architecture for security, additional flip-flops for obfuscation such as dummy flip-flops are inserted into scan chains. Then the correct secret key is added into each test vector at the corresponding position while the key is stored in a part of the secret key that has been confirmed. A correct test response is output when the secret key and the key are identical after comparison while other output is generated once the comparison result is “not identical”. However, all of the methods mentioned above have the same shortcoming that only one secret key is stored in the scan architecture and the secret key is static. Thus the attacker can discover the secret key through a brute force guessing attack easily.

Thus there is a need to provide a novel security system and a method of the same that meet higher security requirements for preventing scan attacks and protecting confidential data in the test circuit.

### SUMMARY OF THE INVENTION

Therefore it is a primary object of the present invention to provide a dynamic secret key security system for test circuit and a method of the same by which different secret keys are generated according to test vectors being input. The secret key is dynamically changed and whether a test vector being input is safe is learned after comparison. Thus a correct response or a fake response is output based on the comparison result.

In order to achieve the above object, a dynamic secret key security system for test circuit according to the present invention includes a scan chain set formed by a plurality of scan chains, a dynamic key generator electrically connected to the scan chain set and used for receiving a test vector from a scan input of the scan chain as inputs, a secret key checking logic electrically connected to the dynamic key generator and the scan chain set, a fake response generator electrically connected to the dynamic key generator and the secret key checking logic, and a controller electrically connected to the dynamic key generator, the secret key checking logic and the fake response generator. Each of the scan chains includes two ends: one end is the scan input while the other end is a scan output. The scan input receives a test vector as inputs.

In order to achieve the above object, a dynamic secret key security method for test circuit according to the present invention includes a plurality of steps. First select a plurality of key flip-flops (KFFs) from a plurality of scan chains of a scan chain set. Then input a seed of a test vector into the scan chains of the scan chain set and a dynamic key generator while the test vector is applied to the scan chains. Next input the test vector into the scan chains in turn; generate a secret key by the dynamic key generator and send a comparison signal to a secret key checking logic by a controller after the test vector being completely input into the scan chains. Lastly compare the test vector in the KFFs with the secret key from the dynamic key generator by the secret key checking logic and output a correct response when the test vector and the secret key are the same. If they are not identical to each other, output a fake response by a fake response generator.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing structure of an embodiment according to the present invention;

FIG. 2 is a schematic drawing showing generation of a dynamic secret key in an embodiment according to the present invention;

FIG. 3 is a schematic drawing showing another generation of a dynamic secret key in an embodiment according to the present invention;

FIG. 4 is a schematic drawing showing a secret key checking logic in an embodiment according to the present invention;

FIG. 5 is a schematic drawing showing a fake response generator in an embodiment according to the present invention.

### DETAILED DESCRIPTION OF THE PREFERRED EMBODIMENT

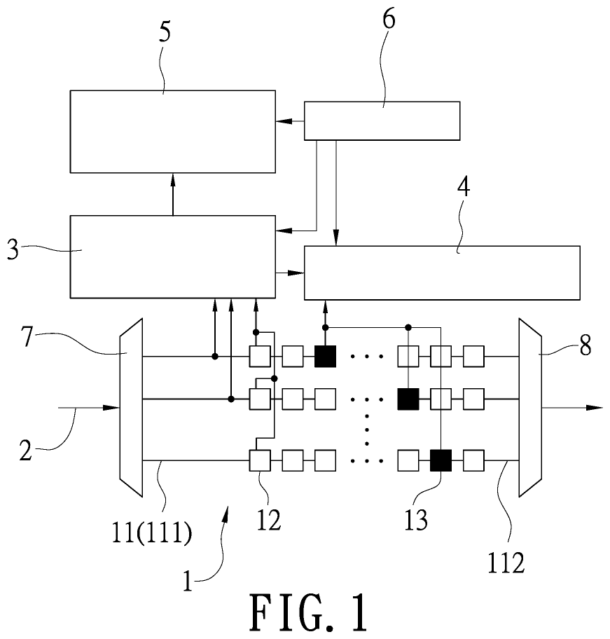

Refer to FIG. 1 to FIG. 5, a dynamic secret key security system for test circuit according to the present invention includes a scan chain set 1, a dynamic key generator 3, a secret key checking logic 4, a fake response generator 5, and a controller 6. The scan chain set 1 includes a plurality of scan chains 11 formed by a plurality of flip-flops 12 connected in series and users can select a plurality of key flip-flops 13 (KFFs) at random from the flip-flops 12. One end of the scan chain 11 is a scan input 111 while the other end is a scan output 112. The scan input 111 receives a test vector 2 as inputs while the scan input 111 of the respective scan chains 11 can be selectively electrically connected to an output of a conventional input decompressor 7 or receiving the test vector 2 directly. The scan output 112 of the respective scan chains 11 of the scan chain set 1 can be selectively electrically connected to an input of a conventional output compressor 8 or directly output without being compressed. The dynamic key generator 3 is electrically connected to the scan chain set 1 and receiving the test vector 2 from the scan input 111 as inputs.

The dynamic key generator 3 consists of a modified-LFSR (linear feedback shift register) 31 and a trigger logic 32 electrically connected to the modified-LFSR 31. The secret key checking logic 4 is electrically connected to both the scan chain set 1 and the dynamic key generator 3 and is composed of a plurality of XNOR (Exclusive NOR) gates 41, an AND gate 42 electrically connected to the XNOR gates 41, and a D flip-flop 43 electrically connected to the AND gate 42. The fake response generator 5 which is electrically connected to the dynamic key generator 3 and the secret key checking logic 4 includes a counter 51, a multiplexer 52 and an XOR gate 53. The counter 51 is electrically connected to the dynamic key generator 3 while the multiplexer 52 is electrically connected to the counter 51 and the scan chain set 1. The XOR gate 53 is electrically connected to the multiplexer 52 and the dynamic key generator 3. As to the controller 6, it is electrically connected to the to dynamic key generator 3, the secret key checking logic 4 and the fake response generator 5.

A dynamic secret key security method for testing circuit according to the present invention includes the following steps.

Step 1: select a plurality of key flip-flops (KFFs) 13 from a plurality of scan chains 11 of a scan chain set 1.

Step 2: input a seed of a test vector 2 into the scan chains 11 of the scan chain set 1 and a dynamic key generator 3 while the test vector 2 is applied to the scan chains 11.

Step 3: input the test vector 2 into the respective scan chains 11 in turn; then generate a secret key by the dynamic key generator 3 and send a comparison signal to a secret key checking logic 4 by a controller 6 after the test vector 2 being completely input into the respective scan chains 11.

Step 4: compare the test vector 2 in the KFFs 13 with the secret key from the dynamic key generator 3 by the secret key checking logic 4 and output a correct response when the test vector 2 is the same as the secret key from the dynamic key generator 3. If the comparison result shows that they are not identical, output a fake response by a fake response generator 5.

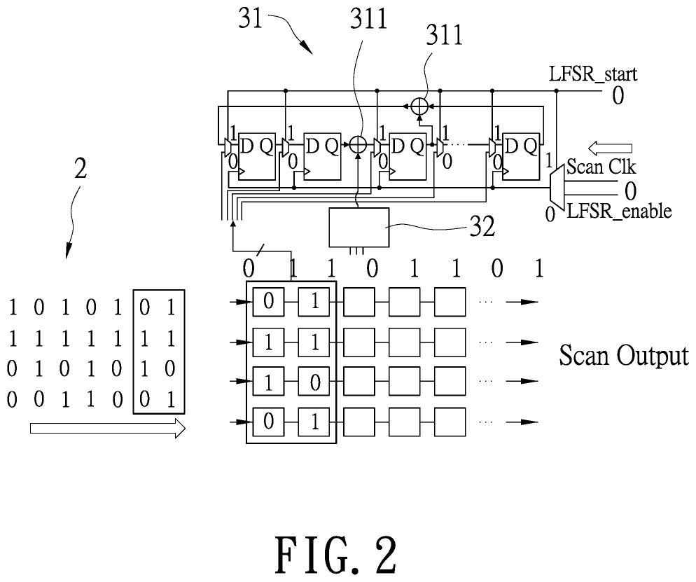

Refer to FIG. 1 to FIG. 5, while in use, firstly a plurality of key flip-flops 13 is selected from the scan chains 11 of the scan chain set 1 and Automatic Test Pattern Generation (ATPG) is used to generate a test vector 2 while a seed is calculated based on the test vector 2. With reference to FIG. 2, the key flip-flops 13 is used to obtain a k-bit seed where k is an integer that can be arbitrarily assigned by the designer, and then the k-bit seed is input into the scan chains 11 of the scan chain set 1 in k/n cycles, where n is the number of scan chains 11. In the beginning, LFSR_start of the modified-LFSR 31 is set as 0 and LFSR_enable is selected as 0 (zero) for control of scan clock (Scan clk). Thus the modified-LFSR 31 will not be affected by the trigger logic 32 while the seed being input. The embodiment of the present invention uses 8-bit seed and four scan chains 11, so the input of the seed being completed after 2 cycles, and LFSR_enable will set as 1 to load the seed into the modified-LFSR 31 of the dynamic key generator 3. After the modified-LFSR 31 loaded the seed, LFSR_start will change to 1 to let the modified-LFSR 31 be drived by scan clk.

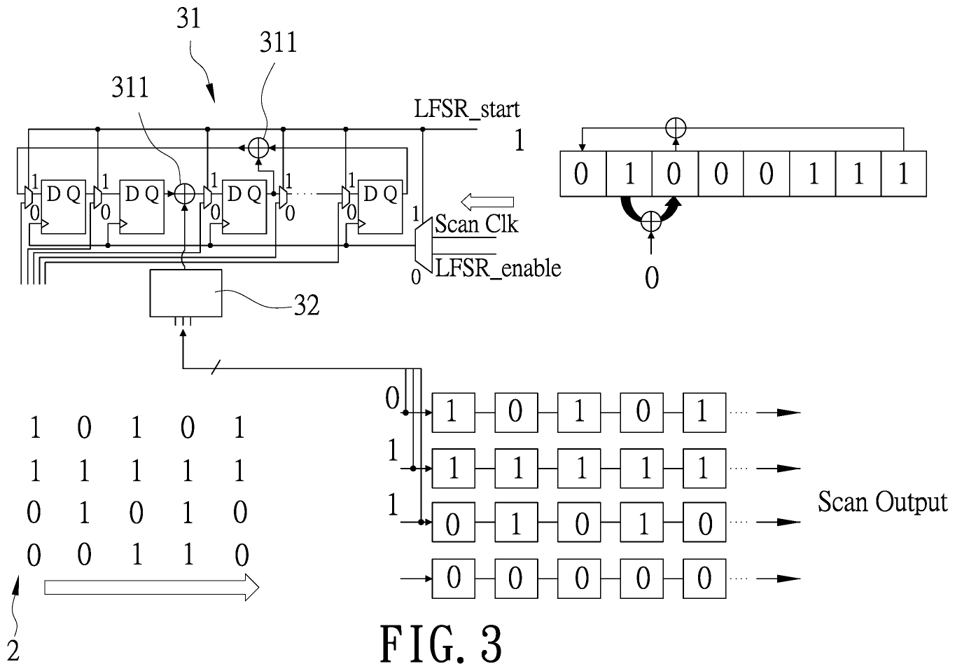

FIG. 3, next the test vector 2 is delivered into the four scan chains 11 of the scan chain set 1 and the key flip-flops 13 receive the test vector 2. In this embodiment, the test vector 2 is delivered into the respective scan chains 11 in turn based on the number of the scan chains 11 (4 bits as a group). The trigger logic 32 changes the contents of the modified-LFSR 31 if at any cycle some specific values appear at the input of the trigger logic 32 during the shift-in of the test vector 2. For example, if some specific 3 bits of the group of 4 bits of the test vector 2 appear at the input to the trigger logic 32 being input includes the three values “011”, the trigger logic 32 sends a trigger signal to the modified-LFSR 31 so that XOR gates 311 in the modified-LFSR 31 works to change the values of the modified-LFSR 31. After the last 4-bit group of the test vector 2 being input into the scan chains 11 completely, the modified-LFSR 31 of the dynamic key generator 3 outputs a secret key.

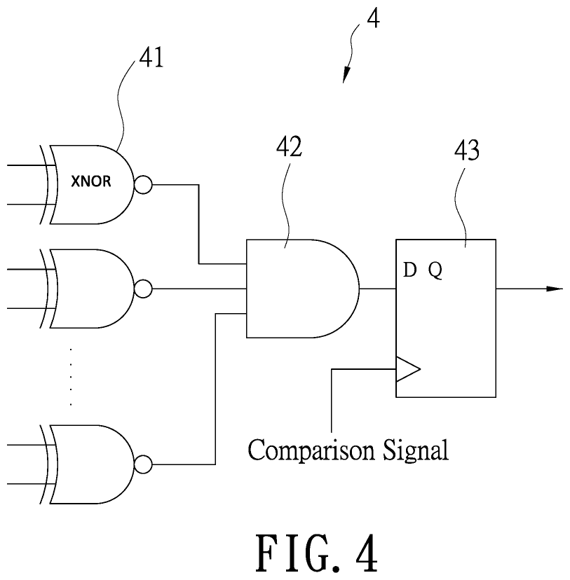

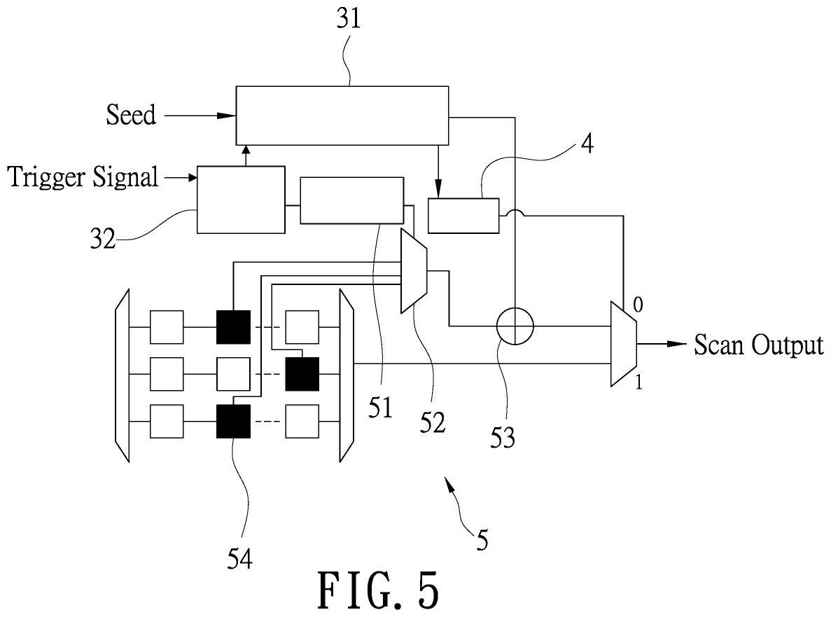

At the moment, the controller 6 sends a comparison signal to the secret key checking logic 4. As shown in FIG. 4, a correct response is output through this architecture once the secret key checking logic 4 confirms that the test vector 2 in the key flip-flops 13 is the same as the secret key produced by the dynamic key generator 3. If the result shows that they are not the same, a fake response is output from the fake response generator 5. How the fake response is generated is shown in FIG. 5. The counter 51 of the fake response generator 5 selects a specific scan flip-flop 54 from a plurality of scan flip-flops according to how many times the trigger signal being received during input of this test vector 2. This scan flip-flop 54 is different from the key flip-flop 13 selected previously. The value of the scan flip-flop 54 selected is used in combination with the secret key of the modified-LFSR 31 to generate the fake response through operation of the XOR gate 53. If attackers input the same illegal test vector 2 repeatedly, the scan flip-flop 54 selected by the counter 51 of the fake response generator 5 remains the same. For the same illegal test vector 2, the fake response generated by the present invention is exactly the same so that the attackers are unable to learn whether the response output is correct or not.

Compared with the techniques available now, the present invention has the following advantages:

1. Based on the present security system and the method of the same, different secret keys are generated according to original data being input. Compared with the conventional techniques using fixed secret keys stored in the circuit, the present invention produces dynamic secret keys that achieve higher security level. Without the secret key stored previously, attackers are unable to obtain the secret key through cold boot attacks.
2. The present system and the method generate the fake responses by the fake response generator. The same fake response is produced for the same illegal test vector so as to confuse attackers.
3. The test vector with a secret key embedded in it can make the security design invisible.
4. Each test vector has its own seed, so every time the attacker wants to get the secret key, the attacker needs to crack from beginning. The present invention maintains a very high security level for each test vector.
5. The present invention does not change the structure of the original circuit under test (CUT), so the present invention cannot lose testability of the original CUT.
6. The present invention has low cost and high security, especially for large scale designs.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A dynamic secret key security system for test circuit comprising:
a scan chain set having a plurality of scan chains each of which includes a scan output disposed on one end thereof and a scan input that is arranged at the other end thereof and used for receiving a test vector as inputs;
a dynamic key generator electrically connected to the scan chain set and used for receiving the test vector from the scan input;
a secret key checking logic electrically connected to the dynamic key generator and the scan chain set;
a fake response generator electrically connected to the dynamic key generator and the secret key checking logic; and
a controller electrically connected to the dynamic key generator, the secret key checking logic and the fake response generator, wherein the fake response generator electrically connected to the secret key checking logic through the controller.

2. The system as claimed in claim 1, wherein the scan input of the scan chain of the scan chain set is selectively electrically connected to an output of an input decompressor while the scan output of the scan chain of the scan chain set is selectively electrically connected to an input of an output compressor.

3. The system as claimed in claim 1, wherein the scan chains are composed of a plurality of flip-flops that are connected in series and having a plurality of key flip-flops (KFFs) able to be selected randomly.

4. The system as claimed in claim 1, wherein the dynamic key generator includes a modified-linear feedback shift register (modified-LFSR) and a trigger logic electrically connected to the modified-LFSR.

5. The system as claimed in claim 1, wherein the secret key checking logic includes a plurality of XNOR (Exclusive NOR) gates, an AND gate electrically connected to the XNOR gates; and a D flip-flop electrically connected to the AND gate.

6. The system as claimed in claim 1, wherein the fake response generator includes a counter electrically connected to the dynamic key generator, a multiplexer electrically connected to both the counter and the scan chain set, and an XOR gate electrically connected to the multiplexer and the dynamic key generator.

7. A dynamic secret key security method for test circuit comprising the steps of:
Step 1: selecting a plurality of key flip-flops (KFFs) from a plurality of scan chains of a scan chain set;
Step 2: inputting a seed of a test vector into both the scan chains of the scan chain set and a dynamic key generator while the test vector is applied to the scan chains;
Step 3: inputting the test vector into the scan chains in turn; then generating a secret key by the dynamic key generator and sending a comparison signal to a secret key checking logic by a controller after the test vector being completely input into the scan chains; and
Step 4: comparing the test vector in the KFFs with the secret key from the dynamic key generator by the secret key checking logic and outputting a correct response when the test vector and the secret key from the dynamic key generator are the same; If the test vector and the secret key are not identical, outputting a fake response by a fake response generator.

8. The method as claimed in claim 7, wherein the scan chain set further includes a scan input, a scan output, a decompressor selectively electrically connected to the scan input and a compressor selectively electrically connected to the scan chains and the scan output.

9. The method as claimed in claim 7, wherein the dynamic key generator includes a modified-linear feedback shift register (LFSR) and a trigger logic electrically connected to the modified-LFSR; the trigger logic is used to alter the contents of the modified-LFSR when specific logic values appear at the inputs of the scan chains, which are also the inputs to the trigger logic.

10. The method as claimed in claim 7, wherein the secret key checking logic includes a plurality of XNOR (Exclusive NOR) gates, an AND gate electrically connected to the XNOR gates, and a D flip-flop electrically connected to the AND gate.

11. The method as claimed in claim 7, wherein the fake response generator includes a counter electrically connected to the dynamic key generator, a multiplexer electrically connected to both the counter and the scan chain set, and an XNOR gate electrically connected to the multiplexer and the dynamic key generator.
